(19) United States
(12) Patent Application Publication
(10) Pub. No.: US 2005/0072720 A1
(43) Pub. Date: Apr. 7, 2005

(54) Point-of-use water softener

(75) Inventor: Carl M. Sutera, North Andover, MA (US)

Correspondence Address: GORDON E NELSON;PATENT ATTORNEY, PC, 57 CENTRAL ST, PO BOX 782, ROWLEY, MA, 01969, US

(73) Assignee: Reign Corporation

(21) Appl. No.: 10/356,946

(22) Filed: Feb. 3, 2003

Related U.S. Application Data
(60) Provisional application No. 60/354,634, filed on Feb. 5, 2002.
(60) Provisional application No. 60/409,329, filed on Sep. 9, 2002.

(51) Int. Cl. C02F 5/00

(52) U.S. Cl. 210/190

(57) ABSTRACT

A portable point-of-use water softener. Settings of a valve put the water softener into three different modes: an “off” mode that excludes water from the water softener, a water softening mode, and a regeneration mode. In water softening mode, water passes from a source of the water through a water softening element to a sink for the softened water. A plurality of water softening elements operate in parallel in water softening mode to increase the flow of water through the water softener. In regeneration mode, a brine solution flows through the water softening element. The solution is made in a chamber in which water from the source flows at a controlled rate over salt tablets and from there through the water softening elements. The number of salt tablets determines the percent of salt in the brine. The valve includes a number of tubes which connect the components as required for the three modes. The valve selects a mode by pinching tubes as required by the mode. The valve uses a cam with a handle to pinch the tubes, and a position of the handle corresponds to each of the modes.

### CROSS REFERENCES TO RELATED APPLICATION

This patent application claims priority from U.S. provisional patent application 60/354,634, Carl Sutera, Portable point-of-use water softener, filed Feb. 5, 2002, and from U.S. provisional patent application 60/409,329, having the same inventor and title, and filed Sep. 9, 2002.

### BACKGROUND OF THE INVENTION

1. Field of the Invention

The invention relates to water softeners generally and more particularly to water softeners which are installed at the point where the soft water is to be used.

2. Description of Related Art

Water softeners have been used for many years to remove undesirable minerals from a dwelling's water supply. Water softeners typically work by running the water through a bed that contains granules of an ion exchange resin. As the water passes through the bed, ions contained in the resin are exchanged for ions of the minerals that harden the water. In the most common case, the ion exchange resin exchanges sodium ions for the undesirable minerals. Of course, the ion exchange resin will work only as long as it has ions to exchange. When the ions are exhausted, the ion exchange reason must be regenerated by passing a solution through the bed which causes the resin to exchange the ions for the undesirable minerals with the ions originally contained in the resin. With ion exchange resins that exchange sodium ions for the undesirable ions, the regeneration is done by passing a brine solution through the bed of ion exchange resin.

Most water softeners are point-of-entry water softeners. They are located at the point where a dwelling's water supply enters the dwelling and soften all of the water supplied to the dwelling. As an integral part of the dwelling's water supply, they are typically installed by plumbers. Once installed, modem point-of-entry water softeners are completely automatic. In addition to the bed of ion exchange resin, they include a tank that contains a saturated brine solution. The brine solution is used to regenerate the ion exchange resin. Under control of either a timer or a device that senses the condition of the softened water, valves are electrically opened and closed so that the resin bed is cut off from the water supply, the saturated brine solution is mixed with water, and the resulting unsaturated brine solution flows through the ion exchange resin until the resin is regenerated. The system then again sets the valves so that the dwelling's water supply flows through the resin bed. Such systems typically employ a simple float valve to ensure that there is water in the brine tank, so all the person in charge of maintaining the system need do is make sure that there is enough salt in the tank to keep the brine solution in the tank saturated.

Point-of-entry water softeners work well for their purposes, but they require that a person who wants soft water in his or her dwelling have control over the dwelling's plumbing. That is easy enough if the dwelling is a house and the person owns the house, but it is another matter entirely when the person merely rents the house or the dwelling is a condominium. Moreover, because point-of entry water softeners soften the entire water supply, they tend to be large and are integrally connected with the rest of the plumbing system and the dwelling's electrical system. As such, they are not portable. Thus, even if a renter or condominium owner had the necessary control over the dwelling's plumbing, he or she could not install a point-of-entry water softener by him or herself or uninstall the water softener and take it along to the next apartment or condominium. For the same reasons, a point-of-entry water softener cannot be easily adapted for use in boats, recreational vehicles, or travel trailers.

Apartment and condominium dwellers have long needed a point-of-use water softener, that is, one that can be easily installed by the user at the point where the soft water is used. For example, soft water is most useful when one is washing one's hair, and point-of-use water softeners have been designed that provided softened water in a sink or shower for that purpose. Examples of such point-of-use water softeners may be found in U.S. Pat. No. 6,422,484, Sasaki, et al, Shower apparatus, claiming priority from a PCT application filed Feb. 8, 1099 and issued Jul. 23, 2002, U.S. Pat. No. 4,242,201, Stephens, et al., By-pass water softener system and installation, issued Dec. 30, 1980, U.S. Pat. No. 3,653,514, Holler, et al., Water softener, issued Apr. 4, 1972, and U.S. Pat. No. 3,016,146, Smith, et al., Portable water treatment device, issued Jan. 9, 1962. All of the point-of-use water softeners disclosed in the above applications have problems that render them difficult to use, and the lack of a successful point-of-use water softener in the marketplace suggests that the art has yet to solve the problems presented by such water softeners. Among the problems are the following:
combining small size with enough flow to make the water softener useful with a shower.
ease of regenerating the resin.
simple operation.

It is an object of the present invention to overcome these problems and provide a point-of use water softener that is portable, user-installable, works with a shower, is easily regenerated, and simply operated.

### SUMMARY OF THE INVENTION

One aspect of the object of the invention is attained by a user-installable water softener. The user-installable water softener includes a water inlet which is connectable by a user to a source of water at a location where the user has need of softened water, a regeneratable water softening element, a source of a regenerating fluid for regenerating the water softening element, and a valve which has a first setting and a second setting. The first setting causes the water to pass through the water softening element and the second setting causes the regenerating fluid to pass through the water softening element. Further details of this aspect include a manually-operated valve with a single handle which has positions corresponding to the settings of the valve and a third setting of the valve which stops the water from flowing through the water softener. There are further more than one of the water softening elements and the water softening elements operate in parallel. The source of regenerating fluid contains salt and when the valve is in its second setting, water passes to the source of the regenerating fluid.

Another aspect of the invention is attained by a water softener that includes an input for water, a regeneratable water softening element, a regeneration fluid source that contains a water-soluble substance, with the regeneration fluid being produced by passing water over the substance, and a valve that in one mode causes the water to pass through the water softening element and in another mode causes the water to pass to the regeneration fluid source and the regenerating fluid produced thereby to pass through the water softening element. Further details of this aspect include that the regenerating fluid passes through the water softening element in a direction which is the reverse of the direction that the water passes through the water softening element, that the valve is manually operable, and that the water for the regeneration source passes through a flow reducer which reduces the flow to a rate which achieves an optimal concentration of the water-soluble substance in the regeneration fluid. Details of the water softening element include a chlorine removal medium, a packed-bed ion exchange resin, and a baffle through which water passes from the chlorine removal medium to the packed-bed ion exchange resin.

A further aspect of the invention is the valve. The valve includes a plurality of pinchable tubes that may be connected to sources and sinks of fluids and a cam having a handle and pinching elements arranged in the cam such that at different positions of the handle, different ones of the plurality of pinchable tubes are pinched. Further details of this aspect include that the plurality of pinchable tubes lie in a single plane and the cam rotates on an axle which is parallel to the plane, that the tubes are reinforced where they are pinched by the pinching elements, and that the pinching elements include axles with rollers, a roller contacting a tube of the plurality when the tube is pinched by the pinching element.

Yet another aspect of the invention relates to regeneration. Regeneration is done by providing water at a constant rate to a brine source which contains one or more salt tablets, with the number of salt tablets determining the concentration of the salt in the brine solution. The salt tablets as received by the user are packaged in a stack and the user takes the number of salt tablets required for the desired concentration from the stack and places them in the brine source.

Other objects and advantages will be apparent to those skilled in the arts to which the invention pertains upon perusal of the following Detailed Description and drawing, wherein:

### BRIEF DESCRIPTION OF THE DRAWING

FIG. 1 is an overview of a water softener that operates according to the principles of the invention;

FIG. 2 is an overview of a preferred embodiment of the point-of-use water softener of the invention;

FIG. 3 shows the valve employed in the preferred embodiment;

FIG. 4 shows the water softening chamber employed in the preferred embodiment;

FIG. 5 shows the regenerating solution source in a preferred embodiment;

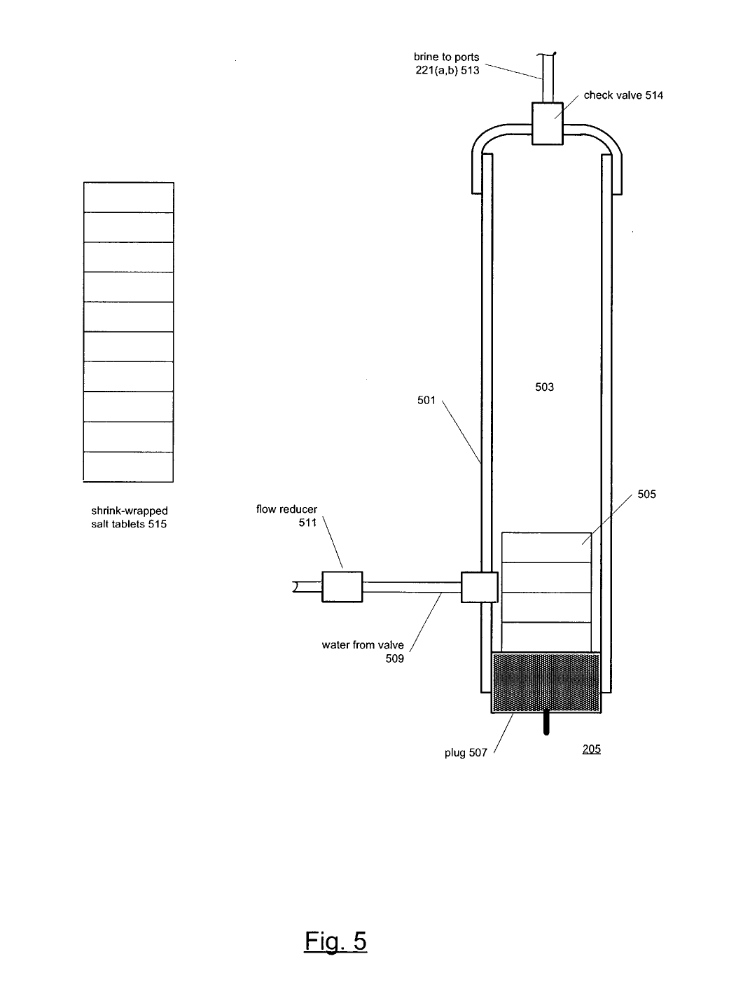

FIG. 6 shows one way of installing the preferred embodiment at the point of use; and

FIG. 7 is a detail of the manner in which valve 207 is connected to the other components of water softener 201.

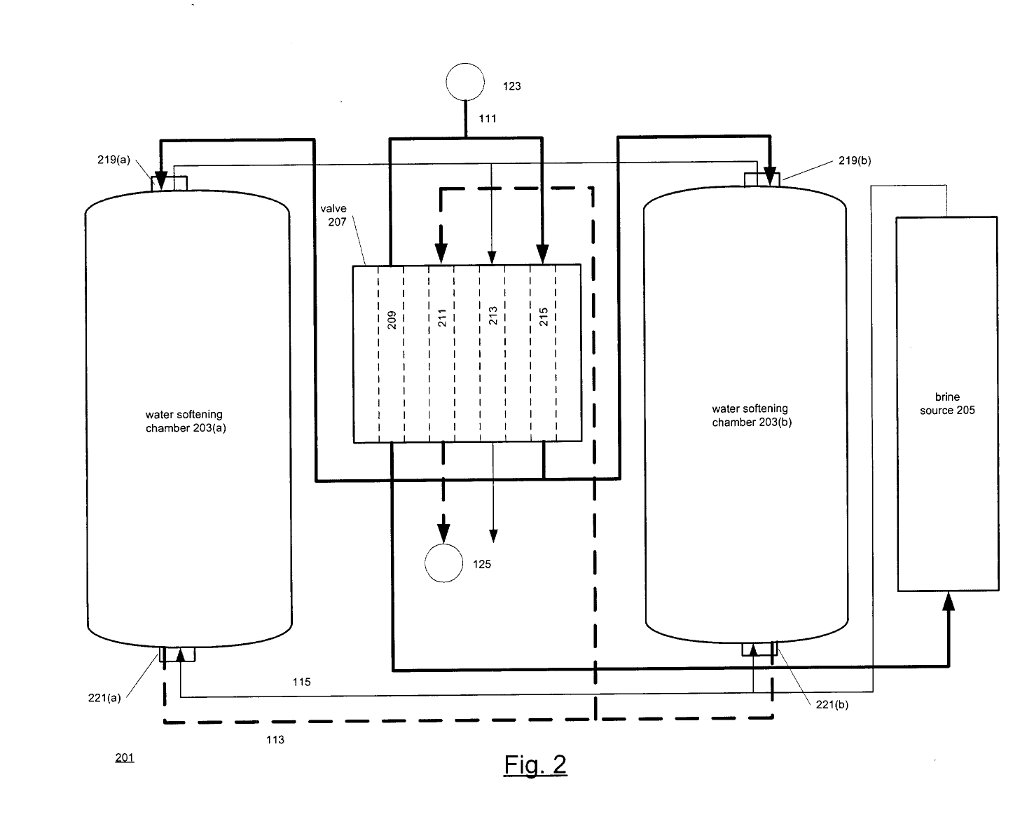

Reference numbers in the drawing have three or more digits: the two right-hand digits are reference numbers in the drawing indicated by the remaining digits. Thus, an item with the reference number 203 first appears as item 203 in FIG. 2.

### DETAILED DESCRIPTION

The following Detailed description will first provide an overview of the construction and operation of a water softener built according to the principles of the invention and will then provide a detailed disclosure of a preferred embodiment.

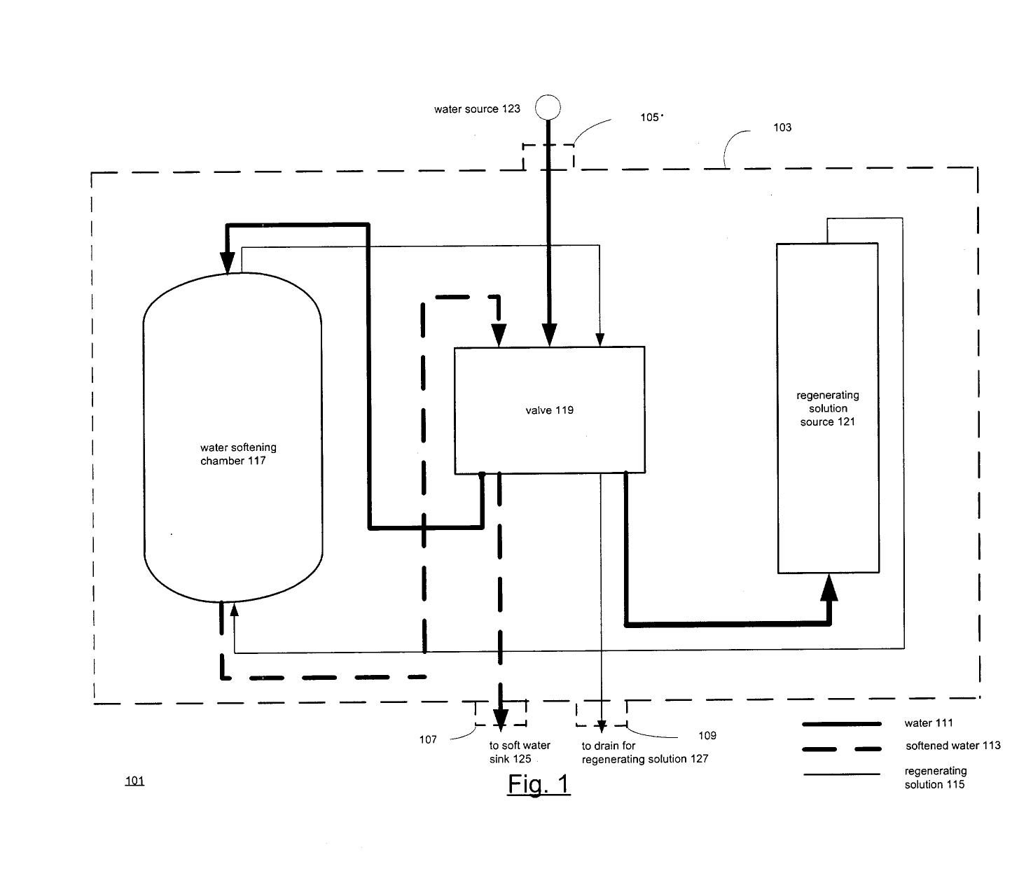

Overview of a Water Softener According to the Invention: FIG. 1

FIG. 1 shows an overview of a water softener 101 which is constructed according to the principles of the invention. The components of water softener 101 are contained in and supported by a case 103 which also provides connections 105 to a water source 123 of water at pressures that are typical in residential water systems, 107 to a soft water sink 125 for soft water produced by water softener 101, and an outlet 109 to a drain for the solution 127 used to regenerate the water softening resin. When water softener 101 is used in a shower enclosure, water source 103 is the source of water for the shower head. Connection 107 is connected to a hose that is in turn connected to a hand-held shower. Outlet 109 simply drains into the shower enclosure's drain. Case 103 may have any useful and/or ornamental form that serves the purpose and may be supported or attached in any practical way at the point of use for the softened water. For example, when used in the shower enclosure, case 103 may hang from the pipe the enclosure's original shower head was attached to.

The chief components of water softener 101 are water softening chamber 117, which contains a bed of ion exchange resins, regenerating solution source 121, which is the source of the regenerating solution used to regenerate the ion exchange resins, and valve 119. Water softening chamber 117 receives water 111 and outputs softened water 113 and also receives and outputs regenerating solution 115. Regenerating solution source 121 receives water 111 and outputs regenerating solution 115. Valve 119 routes water 111 to either water softening chamber 117 or regenerating solution source 121, routes softened water 113 to outlet 107, and routes regenerating solution 115 from water softening chamber 117 to outlet 109. Valve 119 thus controls two modes of operation: a water softening mode and a regeneration mode.

In the water softening mode, valve 119 connects water 111 from source 123 to water softening chamber 117 and softened water 113 from water softening chamber 117 to outlet 107. As the water from source 123 flows through the resin in chamber 117, it is softened. Softened water 113 then flows via valve 119 to connection 107, and thus ultimately to soft water sink 125. While it is doing this, valve 119 also disconnects water 111 from regenerating source 121. Since regenerating solution 115 must be under pressure to flow from regenerating source solution 121 to water softening chamber 117, no regenerating solution reaches water softening chamber 115 in water softening mode.

In the regeneration mode, valve 119 connects water 111 from source 123 to regenerating solution source 121 and disconnects water 111 from chamber 117. The regenerating solution 115 produced when water 111 flows through source 121 goes to water softening chamber 117. Regenerating solution 115 flows through water softening chamber 117, regenerating the resin as it does so, and passes to valve 119, which connects water softening chamber 117 to outlet 109, from which regeneration solution 115 reaches the drain. It should be noted that the regenerating solution 115 could also flow through water softening chamber 117 in a direction opposite to the one shown. The arrangement shown in FIG. 1 is, however, particularly advantageous, since the reverse flow of regenerating solution 115 through water softening chamber 117 also serves to remove material such as mineral scale which may be clogging water softening chamber 117.

Advantages of water softener 101 include the following:
operation is simple because it is completely controlled by valve 119;
regeneration is completely integrated into the operation of water softener 101; and
The regeneration system is pressurized instead of open, which reduces its size and complexity and makes it easy to manage.
   Overview of a Preferred Embodiment: FIG. 2

FIG. 2 provides an overview of a preferred embodiment 201 of water softener 101. The same three components are present, namely water softening chambers 203(a) and (b), a valve 207 that controls whether water softener 201 is operating in water softening or regeneration mode, and a source 205 for the brine that is used to regenerate the ion exchange resins in water softening chambers 203(a) and (b). Each water softening chamber 203 has two ports, 219 and 221. In water softening mode, port 219 receives water 111 and port 221 outputs softened water 113; in regeneration mode, port 221 receives brine 115 and port 219 outputs brine that has passed over the resin in chamber 203. In the preferred embodiment, valve 207 also has an “off” mode in which water 111 is provided neither to water softening chambers 203 nor to brine source 205. As may be noted from the above, water softening and regeneration are both done in water softening chambers 203 in parallel. The parallel operation of the water softening chambers in water softening mode makes it possible to achieve a large volume of flow in a relatively compact water softener.

Valve 207 controls the flow of water 111, softened water 113, and brine 115 in the preferred embodiment by pinching various combinations of four tubes, which appear as 209, 211, 213, and 215 in FIG. 2. This arrangement permits complex flow control in a valve which is relatively small, relatively inexpensive, and easy to operate. Further advantages of this type of valve include the following:
all of the tubes lie in a single plane, giving a low profile;
there are no conventional sealing devices such as “O” rings or gaskets;
there are no moving parts exposed to the corrosive brine solution;
the valve is non-clogging and self cleaning; it offers no discontinuities where scale can accumulate and the pinching action keeps the tubs in the valve free of accumulations of mineral scale;
when the valve handle is moved from one position to another, a momentary “all open” state exists throughout the network of tubing; this in turn creates a pulse or “water hammer” effect which shakes loose sediment from surfaces throughout the system; and
the complex flow control can be achieved using a single handle with three positions.

Operation is as follows: when water softener 201 is in “off” mode, valve 207 pinches tubes 209 and 215, blocking the flow of water 111 to both water softening chambers 203 and brine source 205, when water softener 201 is in water softening mode, valve 207 pinches tubes 209 and 213, but does not pinch tubes 215 and 211. As a result, water 111 flows to water softening chambers 203 but not to brine source 205. The water enters the chambers at port 219 and the softened water leaves at port 221, from whence it goes through tube 211 and outlet 107 to soft water sink 125. When water softener 201 is in regeneration mode, valve 207 pinches tubes 215 and 211 but does not pinch tubes 209 and 213. As a result, water 111 flows to brine source 205, where it passes over salt and becomes brine, and from brine source 205 through ports 211, across the ion exchange resin, through ports 219, and via tube 213 to outlet 109.

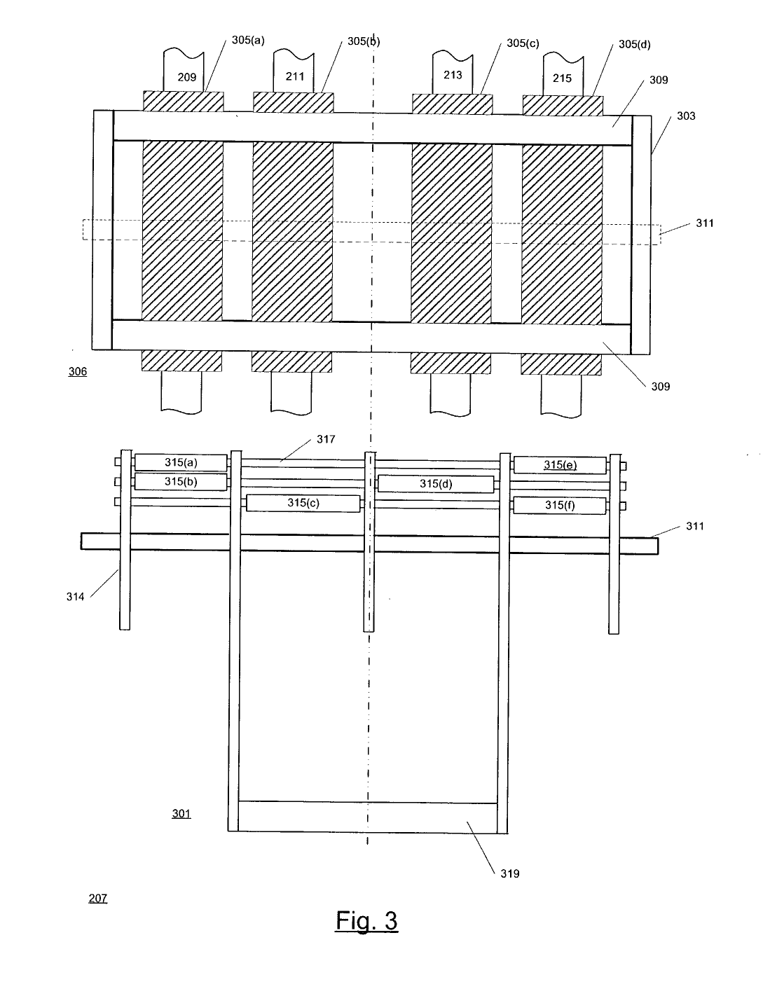

Details of Valve 207: FIGS. 3, 6, and 7

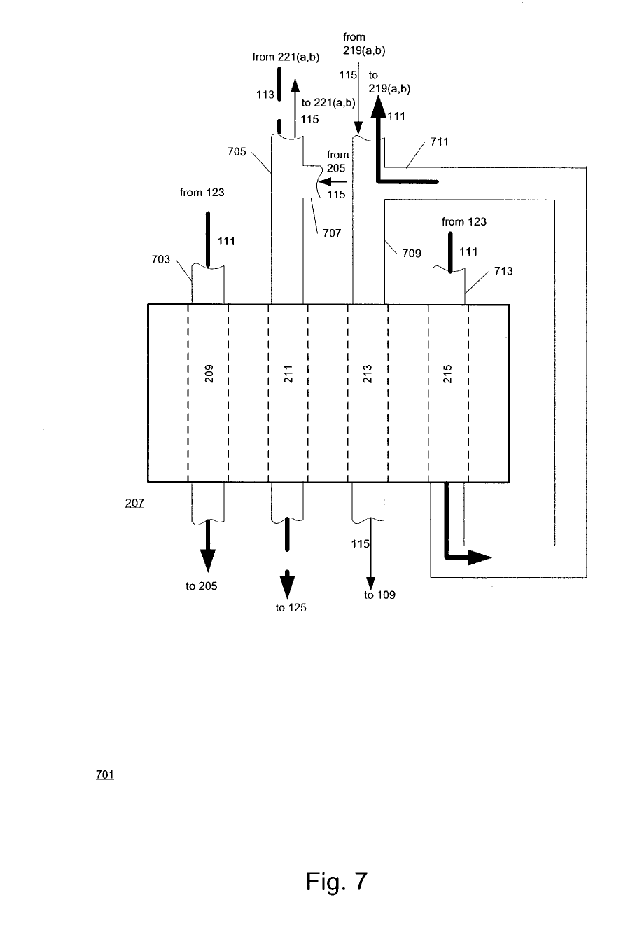

FIG. 7 presents a detail of the connections 701 between valve 207 and the other components of preferred embodiment 201. Beginning with tube 209, this tube connects water supply 123 to brine source 205; when it is pinched, brine source 205 is cut off from water supply 123. Tube 211 connects ports 221(a,b) to soft water sink 125; when the tube is pinched, no soft water flows to soft water sink 125. Tube 211 is joined above valve 207 by tube 707 from the output of brine source 205; when tube 211 is pinched and tube 209 is open, water 111 flows into and brine 115 out of brine source 205 and from thence via tubes 707 and 211 to ports 221(a,b). Tube 213 connects ports 219(a, b) to brine outlet 109; thus when tubes 209 and 213 are open and tubes 211 and 215 are pinched, the brine flows from ports 1221(a, b) through chambers 203(a, b), out ports 219(a, b), and through tube 213 to brine outlet 209. Tube 213 is joined above valve 207 by tube 711, which in turn is connected to tube 215. When tubes 211 and 215 are open and tubes 209 and 213 are pinched, water 111 flows through tube 215, through tube 711, and through tube 213 to ports 219(a,b) and soft water 113 flows from ports 221(a,b) through tube 211 to soft water sink 125.

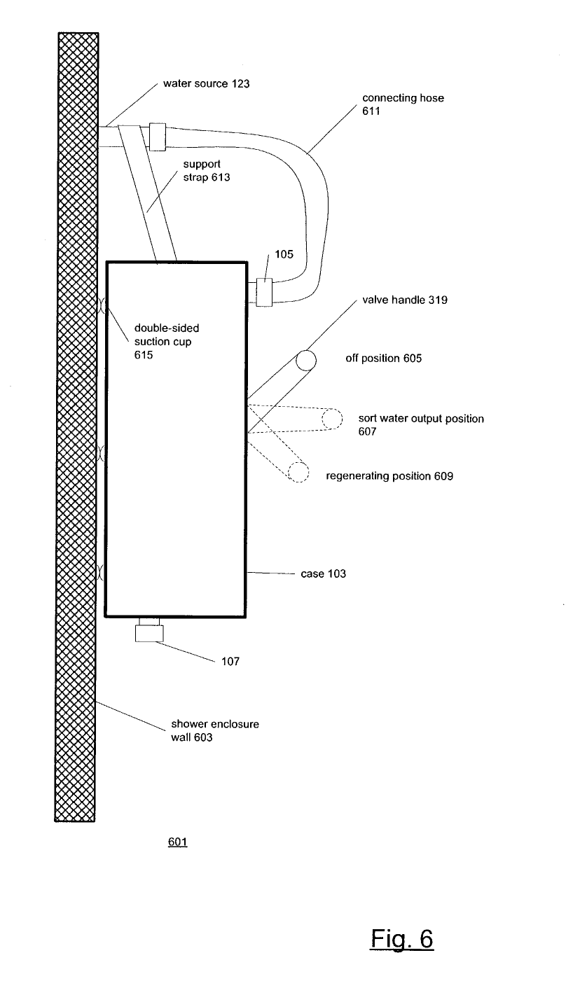

FIG. 3 shows details of the construction of a preferred embodiment of valve 207. Valve 207 has two chief components: tube bed 306, which holds tubes 209-215 so that they can be pinched, and cams 301, which are attached by axle 311 to tube bed 306 and can be rotated by means of handle 319 to pinch various ones of tubes 209-215. As shown at 605, 607, and 609 in FIG. 6, handle 319 has three positions: off position 605, in which the cams pinch tubes 209 and 215, soft water output position 607, in which the cams pinch tubes 209 and 213, but do not pinch 211 and 215, and regenerating position 609, in which the cams pinch tubes 211 and 215 but do not pinch tubes 209 and 213.

Continuing with details of tube bed 306 and cams 301, the reinforced tubes 305 in tube bed 306 are double extruded silicone tubes reinforced with reinforcing yarn. Reinforced tubes 305 are made by extruding the first layer, placing a mesh of reinforcing yarn over the first layer, and then extruding the second layer. Tubing made using this technique combines good flexibility with a good pressure rating. Clamps 309 clamp the reinforced tubes to tube bed 306 and also to connections to the non-reinforced tubing used elsewhere in water softener 201. Bed sides 303 carry axle 311. With regard to cams 301, the individual cams 314 are all rigidly connected to axle 311 and are also joined by axles 317, which carry rollers 315. Two of the individual cams 314 are rigidly connected to handle 319. Axles 317 are placed in the cams such that the rollers 315 pinch the tubes as required for each position of handle 319. Axle 311 is rotatably connected to tube bed 306. As shown by the locations of the rollers, in “off” position 605, rollers 315(a) and 315(e) pinch tubes 209 and 215, blocking the flow of water 111 through water softener 201. In soft water output position 607, roller 315(b) pinches tube 209 and roller 315(d) pinches tube 213, leaving tubes 211 and 215 unpinched, as required for water softening mode. In regenerating position 609, rollers 315(c) and 315(f) pinch tubes 211 and 215, leaving tubes 209 and 214 unpinched, as required for regeneration mode.

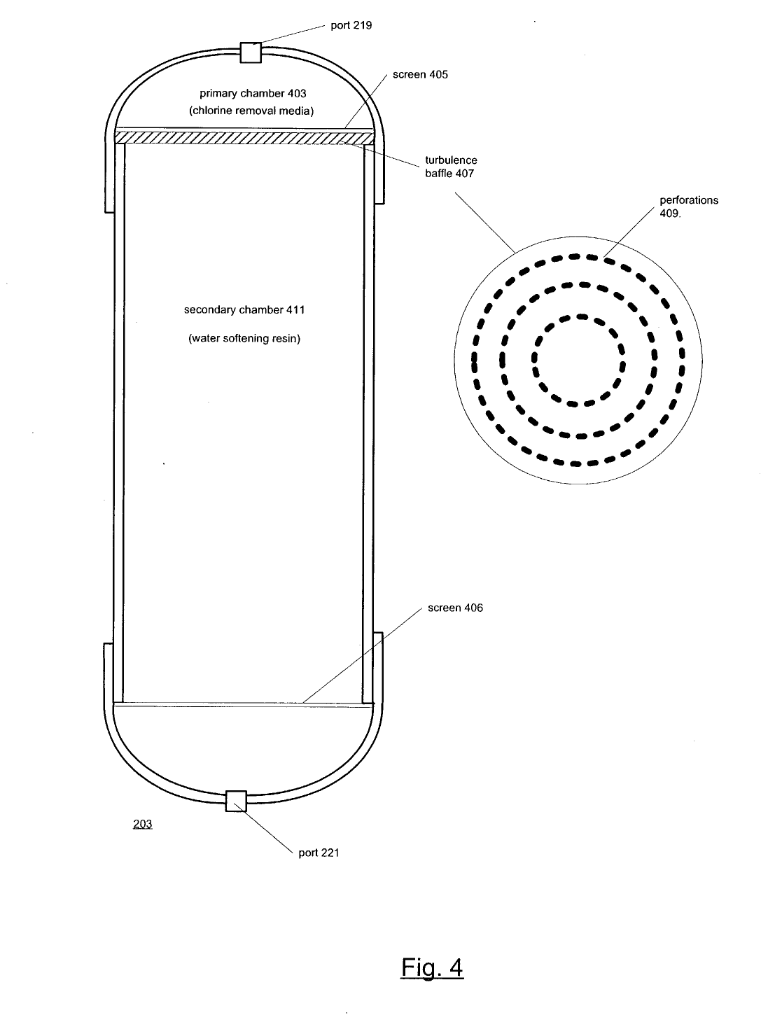

Details of Water Softening Chamber 203: FIG. 4

FIG. 4 shows details of water softening chamber 203. Chamber 203 has a port 219 at its top and a port 221 at its bottom; each of these ports is connected by plastic tubing to valve 207. In water softening mode, water 111 flows in at port 219 and soft water flows out at port 221; in regeneration mode, brine flows in at port 221 and out at port 219. Inside, chamber 203 is divided into primary chamber 403, which contains media for removing chlorine from the water being softened, and secondary chamber 411, which contains the ion exchange resin. The ion exchange resin is retained in chamber 203 by stainless steel screens 405 and 406. The primary and secondary chambers are additionally separated by turbulence baffle 407, which contains perforations 409. The turbulence baffle's functions include:
increasing the period during which water 111 is in contact with the chlorine removal media; preventing the buildup of contaminants on the incoming surface of the chlorine removal media; and
distributing the input water across the entire surface of the exchange resin, which greatly reduces the chance of uneven flows of water through the resin bed.

These functions should be performed without any unnecessary loss of flow through chamber 203; for this reason, the open area provided by perforations 409 should be at least as large as the area of port 219's opening. In a preferred embodiment, water softening chamber 203 has an inside diameter of 3″ and a length of 12″. In general, the wider the chamber is, the greater the rate of flow through it, and the longer it is for a given width, the longer the period between regenerations of the ion exchange resin.

The ion exchange resin bed in secondary chamber 411 employs a packed resin bed design. This design prevents movement of resin granules within the bed and ensures that the resin depletes from the top of chamber 203 down, so that the last resin the water passes over is the least depleted. This insures the maximum possible reduction in hardness. The design is also advantageous for counter-flow regeneration, since the brine regenerates the resin from the bottom up, beginning with the least depleted and ending with the most depleted resin.

Details of Brine Source 205

Brine source 205 is a tube 501 that receives water 111 from valve 207, as shown at 509, and provides brine to ports 221(a,b) of water softening chambers 203(a,b). Flow reducer 511 reduces the rate of flow of water 111 into brine source 205. In a preferred embodiment, the flow reducer is a coupling which contains a Teflon® tube which is of smaller diameter than the tube connected between valve 207 and flow reducer 511. The ratio of the diameters of the tubes determines the degree to which the flow reducer reduces the flow. Output of brine from brine source 205 is via tube 513, which connects to tube 707. Check valve 514 prevents flow of softened water from tube 707 into chamber 503 when valve 207's handle 319 is moved from one position to another.

Chamber 503 of brine source 205 contains salt tablets 505, which are placed in brine source 205 by unscrewing plug 507 from the end of the tube, placing the tablets in the tube, and replacing plug 507. The percentage of salt in the brine solution is determined by the amount of salt in chamber 503 and the rate at which the water 211 flows through chamber 503. That rate is in turn determined by the pressure of the water from source 123 and flow reducer 511. Since the pressure of the water from water source 123 will be more or less constant and the rate of flow through brine source 205 is determined by that pressure and the size of the Teflon tube in flow reducer 511, the percentage of salt in the brine solution will depend primarily on the number of salt tablets 505 in chamber 503. An optimal strength for the brine solution is around 10% salt. To make it easier to both calibrate the amount of salt required to make the 10% brine solution and to put the right amount of salt into chamber 503, the user is provided with the salt in the form of a stack of shrink-wrapped salt tablets 515. The user need only take as many tablets from the stack as are required to produce the 10% salt solution. In a preferred environment, tube 501 is made of transparent plastic and a view port in case 103 permits the user to see how much salt remains in chamber 503.

Details of Regeneration

In the preferred embodiment, it is up to the user to ensure that water softener 201 is operated in regeneration mode sufficiently to keep the ion exchange resin in water softening chambers 203(a,b) able to produce softened water 113. The time required to fully regenerate the resin depends on three factors: the hardness of the water, the flow rate of water from the shower head, and the length of time water softener 201 is in use. The latter is the overriding factor. Some ways in which the user may regenerate the resin in the course of his or her normal showering routine are the following:
1. Put water softener 201 into regeneration mode while waiting for the water to warm up enough to take a shower; when the water is warm, switch to water softening mode.
2. Put water softener 201 into water softening mode while getting wet and put it into regeneration mode while lathering, shampooing, or shaving; when ready to rinse, put the water softener back into water softening mode.
3. Put water softener 201 into regeneration mode while drying off.

The user may of course always regenerate the resin at a set time using a set amount of salt over a set period. Over time, the user will be able to determine the amount or regeneration necessary for the hardness of his or her water and his or her use of the shower. In other embodiments, a timer may be included in the water softener. For example, because of the presence of flow reducer valve 511, the water entering brine source 205 is flowing in a comparatively small tube at comparatively low volume; consequently, a timer might work like this: when the user moves the handle to the position for regeneration mode, the movement of the handle sets the timer, either mechanical, electrical, or electronic, going. While the timer is running, a valve on the input tube is held open; when the timer stops running, the valve closes, cutting off the flow of water to brine source 205 and ending the regeneration period. An example of a timer that would work for this purpose is a 9-volt solenoid valve/timer. An example of a valve would be a pinch valve that worked on the input tube. Other types of timers and valves could of course also be used.

An Exemplary Installation of Water Softener 201: FIG. 6

The manner in which a given water softener 201 will be installed at the point where it is used will of course depend on details of the point of use. FIG. 6 shows an installation 601 of water softener 201 on the wall of a shower enclosure that has the shower head. Case 103 has a support strap 613 which can be placed over water source 123, which is here the pipe that would normally have the shower head. Support strap 613 carries the weight of water softener 201; to keep water softener 201 from sliding on shower enclosure wall 601, double sided suction cups are provided on the back of case 103. These grip on both case 103 and wall 603. The user connects water softener 201 to water source 103 by removing the shower head and connecting hose 611 in its place. The user then connects hose 611 to inlet 105 of water softener 201. The user then connects a shower head on a second hose to softened water outlet 107 of water softener 201. Once water softener 201 is connected as just described to water source 123, the user places valve handle 319 in “off” position 605 and sets the water supply to water source 123 as he or she would normally do for a shower. To take the shower, the user simply places valve handle 319 in soft water output position 607. When the user changes apartments or condominiums, all the user has to do to take water softener 207 along to his or her new dwelling is turn off the water supply to water source 123, disconnect hose 611, and take down case 103. Water softener 207 is thus truly portable in that it can be easily installed and uninstalled by the user and easily transported to the next point of use.

In other applications, the small size and manual mode switching offered by water softener 201 may be more important than portability. Examples of such applications are in boats, recreational vehicles, and travel trailers. In these applications, the water softener may be installed at the point of use in a manner which can withstand the stresses caused by the motion of the boat, RV, or travel trailer or the water softener may even be installed at the point of entry for the plumbing system, that is, at the outlet of the supply tank for the vehicle or boat. In either case, water softener 201 may be installed as a permanent part of the vehicle or boat's plumbing. In an exemplary embodiment for use in a travel trailer, three “J” channels are attached in “U” form to a wall on which the water softener is installed and the case 103 slides into the “U” formed by the “J” channels. Other features of this embodiment include placing the water inlet on the bottom of case 103 to make connecting to the water source easier and shortening the valve handle so that it does not take up too much space in the trailer's tiny shower stall. In still other applications, only the manual mode switching may be of interest, and water softener 201 may be as large as and installed in the same fashion as standard point of entry water softeners with electrical mode switching.

Conclusion

The foregoing Detailed description has disclosed to those skilled in the relevant technologies how to make and use water softeners that incorporate the inventions described herein and has further disclosed the best mode presently known to the inventor of making such water softeners. As part of disclosing the best mode, the inventor has disclosed the best combination known to him of the inventive elements of the water softener, but it will be immediately apparent to those skilled in the relevant arts that various characteristics of the invention may be achieved by using embodiments other than those disclosed herein.

For example, the convenience of the water softener stems in great part from the fact that regeneration may be done by simply setting the valve to its second setting. The planar pinch valve used in the preferred embodiment is particularly advantageous for the purpose, but any other valve which permits the user to place the water softener into regeneration mode would also work. The brine source used in the preferred embodiment is also particularly advantageous, since the water pressure from the water source drives the brine solution through the water softening chambers, but any other source of brine that could be turned on by the valve would also work. By the same token, a brine source with the easy calibration features of the one disclosed herein is advantageous, but not necessary to the broad concept of the invention. The same is true of such detailed features of the water softening chamber as the chlorine chamber, the baffle between the chlorine chamber and the water softening chamber, or the packed bed resin in the water softening chamber. As one would expect, the number of water softening chambers, the manner in which the valve connects the components, and the manner in which the water softener is installed and connected to the water source and/or the soft water sink may also vary from embodiment to embodiment.

For all of the foregoing reasons, the Detailed Description is to be regarded as being in all respects exemplary and not restrictive, and the breadth of the invention disclosed here in is to be determined not from the Detailed Description, but rather from the claims as interpreted with the full breadth permitted by the patent laws.

1. A water softener for softening water at a point of use for soft water in a plumbed unit rather than at a point of entry to the plumbed unit, the water softener comprising:
a user-carryable unit which includes
a water inlet which the user connects at the point of use to a source of water;
a regeneratable water softening element;
a source of a regenerating fluid for regenerating the water softening element; and
a manually-operated valve, the valve being connected to the water inlet, the water softening element, and the source of the regenerating fluid and having a first setting which causes the water to pass from the inlet through the water softening element and a second setting which causes the regenerating fluid to pass through the water softening element.

2. (canceled)

3. The water softener set forth in claim 2 wherein:
the valve has a third setting which stops the water from flowing through the water softener.

4. The water softener set forth in claim 3 wherein:
the valve has a single handle and the handle has positions corresponding to the first, second, and third settings.

5. The water softener set forth in claim 1 wherein:
the valve operates by pinching flexible tubes connecting the water input, the water softening element, and the source of the regenerating fluid as required to cause the water to pass through the water softening element and the regenerating fluid to pass through the water softening element.

6. The water softener set forth in claim 1 wherein:
there is a plurality of the water softening elements and when the valve has the first setting, the water passes through the plurality of water softening elements in parallel.

7. The water softener set forth in claim 1 further comprising:
a soft water outlet that receives the softened water from the water softening element and that is connectible by the user to a sink for the softened water.

8. The water softener set forth in claim 1 wherein:
the regenerating fluid is brine produced by dissolving salt contained in the source of the regenerating fluid in the water; and
the second setting further causes the water to pass to the source of the regenerating fluid.

9. The water softener set forth in claim 8 wherein:
the valve has a third setting which prevents the water from passing either through the water softening element or to the source of the regenerating fluid.

10. The water softener set forth in claim 9 wherein the valve comprises:
a first pinchable tube that connects the water inlet to the source for the water regenerating fluid;
a second pinchable tube that connects the water softening element to a soft water outlet; and
a third pinchable tube that connects the water softening element to an outlet for the brine;
a fourth pinchable tube that connects the water inlet to the water softening element; and
a cam having a handle and pinching elements arranged in the cam such that
the first setting is a first position of the handle such that the pinching elements do not pinch the second pinchable tube and the fourth pinchable tube and do pinch the first pinchable tube and the third pinchable tube,
the second setting is a second position of the handle such that the pinching elements do not pinch the first pinchable tube and the third pinchable tube and do pinch the second pinchable tube and the fourth pinchable tube, and
the third setting is a third position of the handle such that the pinching elements pinch the first and fourth pinchable tubes.

11. A water softener comprising:
an input for water, the water being under pressure;
a regeneratable water softening element;
a regeneration fluid source that contains a water-soluble substance, the regeneration fluid being produced by passing water over the substance; and
a manually-operated valve, the valve being connected to the input and having that Done mode that causes the water to pass through the water softening element and in another mode that causes the water to pass through the regeneration fluid source and causes the regeneration fluid produced thereby to pass through the water softening element.

12. The water softener set forth in claim 11 wherein:
the regeneration fluid passes through the water softening element in a direction which is the reverse of the direction that the water passes through the water softening element.

13. (canceled)

14. The water softener set forth in claim 11 further comprising:
a flow reducer which reduces the flow of water into the regeneration fluid source as required to achieve an optimal concentration of the water-soluble substance in the regeneration fluid.

15. The water softener set forth in claim 11 wherein the water softening element comprises:
a water inlet;
a soft water outlet;
a chlorine removal medium which receives the water from the water inlet;
a packed-bed ion exchange resin which receives the water from the chlorine removal medium and provides the softened water to the soft water outlet;
screens which retain the ion exchange resin in place; and
a baffle through which the water flows from the chlorine removal medium to the packed-bed ion exchange resin.

16. The water softener set forth in claim 11 wherein:
the water-soluble substance is salt; and
the regeneration fluid source is openable to permit insertion of one or more salt tablets therein.

17. (canceled)

18. (canceled)

19. (canceled)

20. (canceled)

21. (canceled)

22. (canceled)

23. (canceled)

24. (canceled)

25. The water softener set forth in claim 1 wherein:
the source of regenerating fluid contains a water-soluble substance and produces the regenerating fluid by passing water over the water-soluble substance; and
the second setting causes the regenerating fluid to pass through the water softening element by causing the water to pass from the inlet through the source of the regenerating fluid.
